(19) United States
(12) Patent Application Publication
(10) Pub. No.: US 2025/0307491 A1
(43) Pub. Date: Oct. 2, 2025

(54) ARTIFICIAL INTELLIGENCE ASSISTED DESIGN AND FABRICATION OF SEMICONDUCTOR DEVICES

(71) Applicants: Mitsubishi Electric Research Laboratories, Inc., Cambridge, MA (US); Mitsubishi Electric Corporation, Chiyoda-ku Tokyo (JP)

(72) Inventors: Koon Hoo Teo, Lexington, MA (US); Xiaofeng Xiang, Seattle, WA (US); Nadim Chowdhury, Cambridge, MA (US); Eiji Yagyu, Tokyo (JP)

(73) Assignees: Mitsubishi Electric Research Laboratories, Inc., Cambridge, MA (US); Mitsubishi Electric Corporation, Chiyoda-ku Tokyo (JP)

(21) Appl. No.: 18/618,360

(22) Filed: Mar. 27, 2024

(51) Int. Cl. G06F 30/18

(52) U.S. Cl. CPC G06F 30/18

(57) ABSTRACT

A method for designing a field plate of a semiconductor device comprises collecting a surrogate model connecting structural parameters of the field plate design of the semiconductor device with a performance metric of the semiconductor device including multiple variables having a Pareto Front. Using the surrogate model different combinations of the structural parameters of the field plate design resulting in the performance metrics lying on the Pareto Front are evaluated to produce an optimal combination of the structural parameters. The method also comprises outputting the optimal combination of the structural parameters.

### TECHNICAL FIELD

The present disclosure relates generally to semiconductor devices, and more particularly to systems, methods, and programs for artificial intelligence (AI) assisted design and fabrication of semiconductor devices.

### BACKGROUND

Several high-end applications require high-speed semiconductor devices to perform critical functions. Meeting the demanding performance requirements of these devices without compromising reliability is a challenging endeavor. For example, during high-voltage operations, the risk of device failure is concentrated near the gate edge due to the maximum electric field. To mitigate this risk, field plates are employed to distribute the electric field along the channel, reducing the peak electric field and enhancing device reliability. The distribution of the electric field along the channel is conditional upon the field plate design. However, due to the complex geometry of field plate structures resulting in a large design space and complex underlying physics, the design search, optimization, and subsequent fabrication task becomes a very complex and time-consuming process.

Accordingly, there is a need for reliable, fast, and computationally efficient approaches for designing and fabricating semiconductor devices that meet performance standards for high-tech applications.

### SUMMARY

It is an objective of some example embodiments to provide systems and methods for designing and/or fabricating semiconductor devices using AI-based approaches. Some embodiments are directed towards systems and methods for the field plate design of a semiconductor device using a surrogate model connecting structural parameters of the field plate design with a performance metric of the semiconductor device. Some example embodiments provide an optimal combination of the structural parameters of the field plate design of the semiconductor device for fabricating the semiconductor device with a field plate design governed by the optimal combination of structural parameters.

Some embodiments are based on a recognition that for the field plate design of a semiconductor device such as a Gallium Nitride (GaN) high electron mobility transistor (HEMT) device, there is a need to connect specific structural parameters of the GaN HEMT device with key performance metrics of the GaN HEMT device. According to some embodiments, the specific structural parameters include locations and geometry of the gate field plate, source field plate, and metal contacts (relative location and geometry of source, gate, and drain) while the key performance metrics may include blocking voltage, gate leakage, and capacitance.

Some embodiments are based on a recognition validated by testing and experimentation that there is a learnable statistical relationship between these specific structural parameters and the key performance metrics of GaN HEMT devices. Hence, it is possible to learn a surrogate model defining this mapping from simulations of various exemplary Technology Computer Aided Designs (TCAD) of the GaN HEMT devices. Some embodiments recognize that learning the surrogate model is much faster compared to TCAD simulation. Also, some embodiments recognize that TCAD simulations are not suitable for inverse design, while ML surrogate model can easily achieve it by combination with an optimizer.

Through experimentation, some embodiments realized that there exists a Pareto Front for the key performance metrics of GaN HEMT devices. Accordingly, it is a realization of some embodiments that different values of the structural parameters may be efficient choices for designing the GaN HEMT devices. However, some embodiments are also based on the realization that is a need to make tradeoffs within this set of all Pareto efficient solutions, rather than considering the full range of every parameter.

Therefore, to design a semiconductor device, it is sub-optimal and mostly insufficient to just train a surrogate model that can optimize the structural parameters for a given performance metric. Instead, some embodiments provide an approach to design the surrogate model by evaluating performance metrics for given structural parameters and searching within all Pareto efficient solutions defined by outputs of the surrogate model. Some embodiments provide implementation of such approaches with genetic optimization algorithms such as Non-Dominated Sorting Genetic Algorithm II (NSGA-II), NSGA-III, and other multi-objective optimization algorithms. This approach is advantageous because it allows to use advantages of fast computation of the surrogate model while mitigating the disadvantages of the statistical black box nature of machine learning with an optimization approach.

An example of a response function for the entire design space of plate design of a semiconductor device includes a pulse function that can reconstruct the location and geometry of the field plate from the parameters of the pulses. This type of response function is advantageous. Firstly, it reduces 2D problems into 1D. Secondly, 1D pulse functions have a specific mathematical format, which can be further explored with optimization schemes and physics-informed Neural Networks (PINN).

Thus, various embodiments provide solutions for designing a surrogate model connecting structural parameters with performance metrics in such a manner that the Pareto Front can be evaluated for the key performance metrics within an optimization framework.

In order to achieve the aforementioned objectives and advantages, systems, methods, and computer program products for designing a field plate of a semiconductor device are provided.

According to some embodiments, a method for designing a field plate of a semiconductor device is provided. The method comprises collecting a surrogate model connecting structural parameters of the field plate design of the semiconductor device with a performance metric of the semiconductor device including multiple variables having a Pareto Front. Using the surrogate model different combinations of the structural parameters of the field plate design resulting in the performance metrics lying on the Pareto Front are evaluated to produce an optimal combination of the structural parameters. The method also comprises outputting the optimal combination of the structural parameters.

In yet some other embodiments, a system for designing a field plate of a semiconductor device is provided. The system comprises memory configured to store instructions and a processor configured to execute the instructions to collect a surrogate model connecting structural parameters of the field plate design of the semiconductor device with a performance metric of the semiconductor device including multiple variables having a Pareto Front. The processor evaluates using the surrogate model, different combinations of the structural parameters of the field plate design resulting in the performance metrics lying on the Pareto Front to produce an optimal combination of the structural parameters. The optimal combination of the structural parameters is output by the processor.

In yet some other embodiments, a non-transitory computer readable medium having stored thereon computer executable instructions that when executed by a computer cause the computer to perform a method for designing a field plate of a semiconductor device is provided. The method comprises collecting a surrogate model connecting structural parameters of the field plate design of the semiconductor device with a performance metric of the semiconductor device including multiple variables having a Pareto Front. Using the surrogate model different combinations of the structural parameters of the field plate design resulting in the performance metrics lying on the Pareto Front are evaluated to produce an optimal combination of the structural parameters. The method also comprises outputting the optimal combination of the structural parameters.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a method for designing a field plate of a semiconductor device, according to some embodiments;

FIG. 1B illustrates a framework for designing a semiconductor device, according to some embodiments;

FIGS. 2A and 2B jointly illustrate schematics of a two-dimensional (2D) field plate geometry transformation process, according to some embodiments;

FIG. 2C illustrates a workflow for converting slant field plate into a pulse function via coupling of rectangular and sawtooth pulse functions, according to some embodiments;

FIGS. 3A and 3B each illustrate an exemplary architecture of the surrogate model's neural network featuring three output layers, according to some embodiments;

FIG. 4A illustrates the training and validation results corresponding to the blocking voltage (BV) and the gate leakage current of the semiconductor device, according to some embodiments;

FIG. 4B illustrates the training and validation results corresponding to the capacitance variable, according to some embodiments;

FIG. 5 illustrates a table showing the training and validation results corresponding to each performance metric of FIGS. 4A and 4B, according to some embodiments;

FIG. 6A illustrates an AI-assisted optimization framework for field plate design for optimizing all key performance metrics of the semiconductor device;

FIG. 6B illustrates an AI-assisted optimization framework for field plate design to reach closely to a target key performance metric and optimize other key performance metrics;

FIG. 7 illustrates a block diagram showing incremental learning of a neural network (NN) surrogate model, according to some embodiments;

FIG. 8A illustrates Pareto Front generated via an AI-assisted model for device optimization, according to some example embodiments;

FIG. 8B illustrates Pareto Front for inverse design of GaN HEMT with a target blocking voltage, according to some example embodiments;

FIG. 9A illustrates NN prediction and TCAD validations results of a subset of Pareto Front for BV (V), gate leakage (mA/mm) and Cgd (pF/mm) optimization;

FIG. 9B illustrates neural network (NN) prediction and TCAD validations results of a subset of Pareto Front for inverse design with a target BV;

FIG. 10A illustrates a 2D schematic of GaN HEMT device structure of a Pareto Front in the table of FIG. 9B, according to some embodiments;

FIG. 10B illustrates the dimensions of the structure of the GaN HEMT of FIG. 10A, according to some embodiments; and

FIG. 11 illustrates a block diagram of some components of the system of FIG. 1B, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of the ordinary skills in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, similar reference numbers and designations in the various drawings indicate similar elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Semiconductor manufacturers face the challenge of developing process technologies within strict time and cost constraints. GaN High Electron Mobility Transistors (HEMTs) have found extensive use in high-power and high-frequency electronic devices, including chargers, RF, and microwave power applications. GaN HEMT plays a vital role in high-power and high-frequency electronics. Meeting the demanding performance requirements of these devices without compromising reliability is a challenging endeavor. For example, in high-voltage operations, the risk of device failure is mainly concentrated near the gate edge due to the maximum electric field.

An important measure to combat or avoid the risk of device failure is the use of field plates with the electrodes of the semiconductor device. Such plates are employed to redistribute the electric field at the heterogeneous contacts reducing the peak electric field and enhancing device reliability. The efficacy of these field plates and avoidance of side effects largely depends on the design of such plates. Particularly, the field plates must conform to structural as well as performance parameters and requirements for hassle-free operations and to achieve the field plates' intended objectives. However, complexity and variations in the structural geometry of the field plates can lead to a very large design space, and the design search task in such cases becomes very lengthy and complex, often hampering the fabrication needs of the semiconductor devices utilizing the field plates.

For example, Technology computer-aided design (TCAD) simulations can be used to model semiconductor fabrication and semiconductor device operations. However, TCAD simulations are generally based on finite-element solver dynamics, which can be computationally prohibitive, particularly when involving a large-scale optimization goal such as multi-scale, mixed-mode optimization, as is with field plate designing. Additionally, predicting control settings for a large-scale optimization goal using TCAD simulations may involve executing multiple TCAD models simultaneously and capturing the circuit-level dynamics through optimizing fabrication process inputs, which may lead to instability and increased computational complexity.

Some embodiments have recognized that machine learning (ML) techniques can be applied to semiconductor device design to accelerate their production and avoid potential errors during design. For example, one approach in this regard may be to combine TCAD with machine learning and optimization techniques to optimize GaN device design. However, such combinatorial approaches are applicable only to a small subset of problems, particularly those with relatively simple device structures characterized by a limited set of design parameters. The application of ML techniques for field plate structures, known for their geometric complexity, is either unexplored or suboptimal for fabrication standards. This is in part due to the inherent large design space resulting from the substantial geometric variations of the field plates which makes even ML-based solutions time-consuming for optimal designing of the field plates.

Example embodiments provided herein provide measures to accelerate the field plate design task by streamlining the field plate design process using a combination of technology computer-aided design (TCAD), machine learning, and optimization approaches. Some embodiments transform the complex two-dimensional (2D) field plate structures into a concise feature space, reducing data requirements and thereby enabling their integration into machine learning models. A machine learning-assisted design framework is proposed in some embodiments to optimize field plate structures and perform inverse design. The proposed approach is applicable to a wide variety of semiconductor devices with field plate structures including, but not limited to GaN HEMTs, Si, SiC, and GaAs based transistors, to name a few.

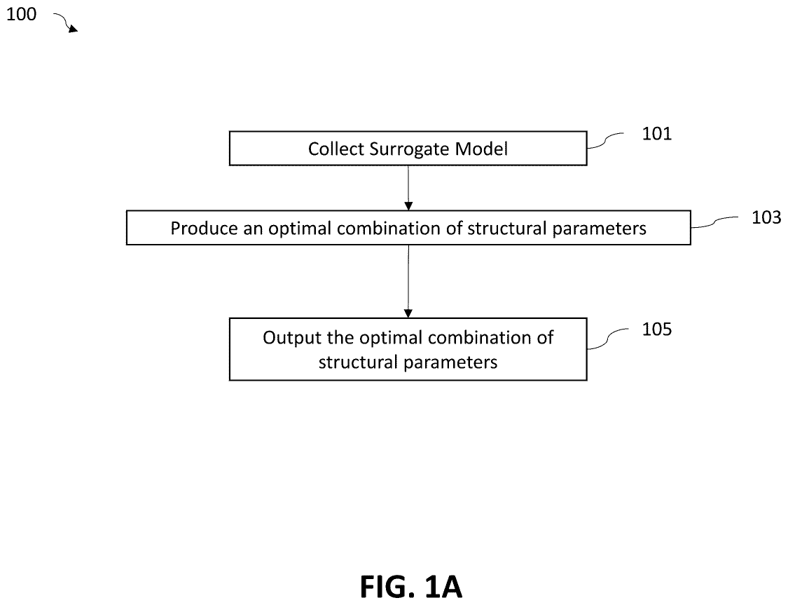

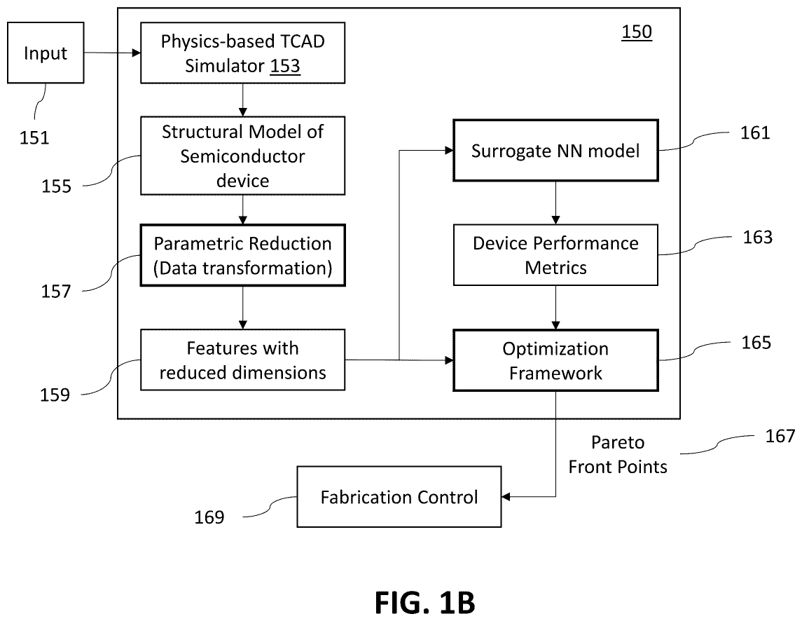

FIG. 1A illustrates a method 100 for designing a field plate of a semiconductor device. The semiconductor device may be a transistor or a transistor-based device. The method 100 may be executed by a computer-implemented system that runs software programs and performs data exchange. Structural parameters defining geometric variations and properties of the semiconductor device are obtained, for example from a simulator module. The structural parameters of the semiconductor device may include one or more distances between the electrodes of the semiconductor device. of the distance between the gate and the source of the semiconductor device, the distance between the gate and drain of the semiconductor device, the metal thickness of one or more of the gate, source and drain of the semiconductor device, a thickness of gate field plate, a length of left side gate field plate, a length of right-side gate field plate, the horizontal location of source field plate, the vertical location of source field plate, thickness of source field plate, length of source field plate.

The structural parameters may be obtained from a suitable simulator such as a Technology CAD (or Technology Computer Aided Design, or TCAD) simulator. TCAD is a branch of electronic design automation that models semiconductor fabrication and semiconductor device operation. The modeling of the fabrication is termed Process TCAD, while the modeling of the device operation is termed Device TCAD. Included are the modelling of process steps (such as diffusion and ion implantation), and the modelling of the behavior of the electrical devices based on fundamental physics, such as the doping profiles of the devices. TCAD may also include the creation of compact models (such as the well-known SPICE transistor models), which try to capture the electrical behavior of such devices but do not generally derive them from the underlying physics. TCAD simulators are general purpose simulators that solve fundamental physics questions. TCAD simulators can handle an immensely large variety of structures and simulation conditions, including unexpected and yet-to-be-discovered structures.

The method comprises collecting 101 a surrogate neural network model that connects the structural parameters of the field plate design of the semiconductor device with performance metrics of the semiconductor device including multiple variables having a Pareto Front. The surrogate model is trained to predict key performance metrics of the semiconductor device, given the structural parameters. The performance metrics may include a blocking voltage (BV), a gate voltage leakage, and a capacitance optimization variable. According to some embodiments, the performance metrics may include current collapse.

The method 100 further comprises producing 103 an optimal combination of the structural parameters. In this regard, the method 100 invokes the surrogate model to evaluate different combinations of the structural parameters of the field plate design resulting in the performance metrics lying on the Pareto Front. The optimal combination of the structural parameters thus obtained is output 105 for further processing or control.

According to some embodiments, the optimal combination of the structural parameters may be used for generating a design of the semiconductor device. In yet some embodiments, the optimal combination of the structural parameters may be used for controlling a fabrication controller to fabricate a semiconductor device. In this regard, the fabrication controller may generate one or more control commands to control one or more actuators or other assembly components to fabricate the semiconductor device in accordance with the optimal combination of the structural parameters.

FIG. 1B illustrates a framework for designing a semiconductor device, according to some embodiments. An input 151 including structural and performance specifications of the subject semiconductor device is provided to system 150 via an interface of system 150. The system 150 executes a physics based TCAD simulator 153 on the input 151 to generate a structural model 155 of the semiconductor device. The Structural Model 155 defines the structural parameters of the semiconductor device. As described previously, field plate structures are known for their geometric complexity which results in a large design space in the structural model 153. Thus, the field plate structure defined in the structural model 155 is a complex two-dimensional (2D) space that is not suitable for integration with ML techniques.

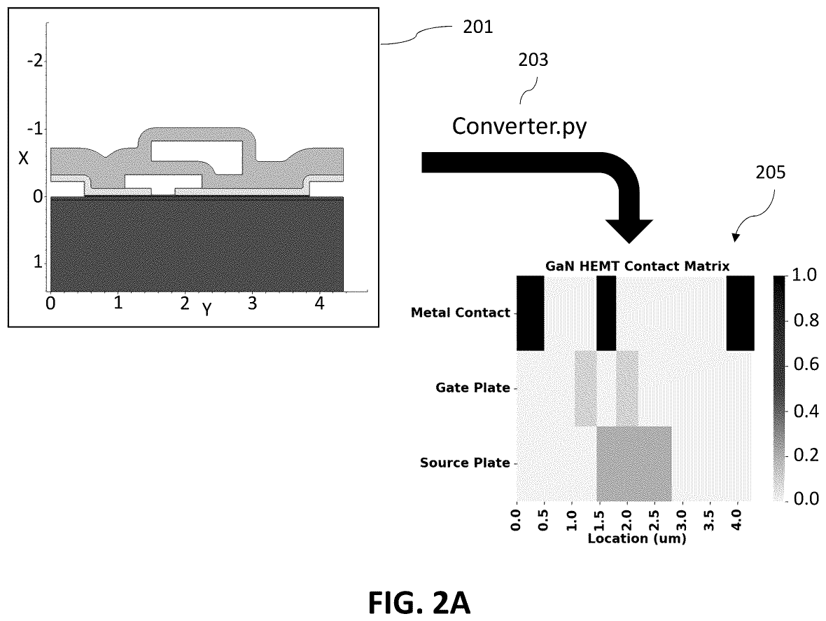

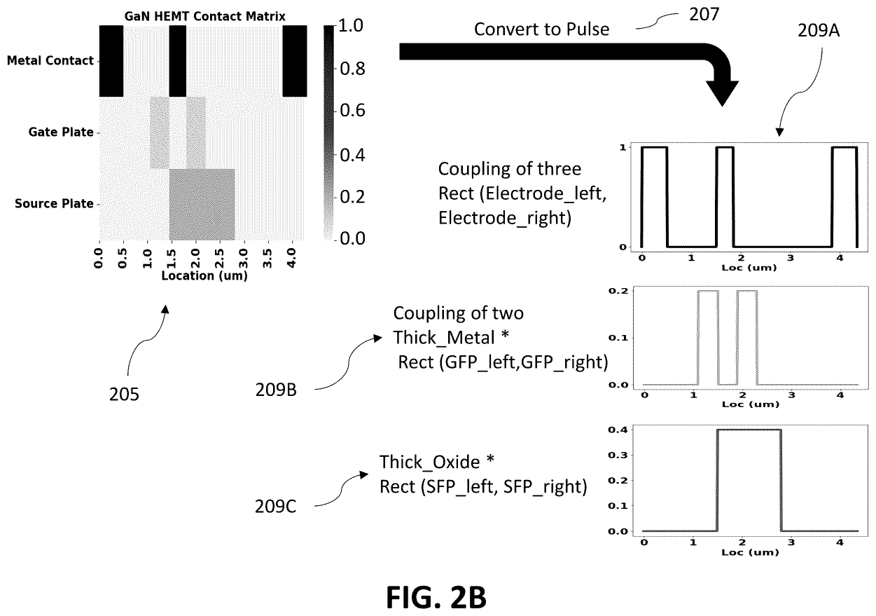

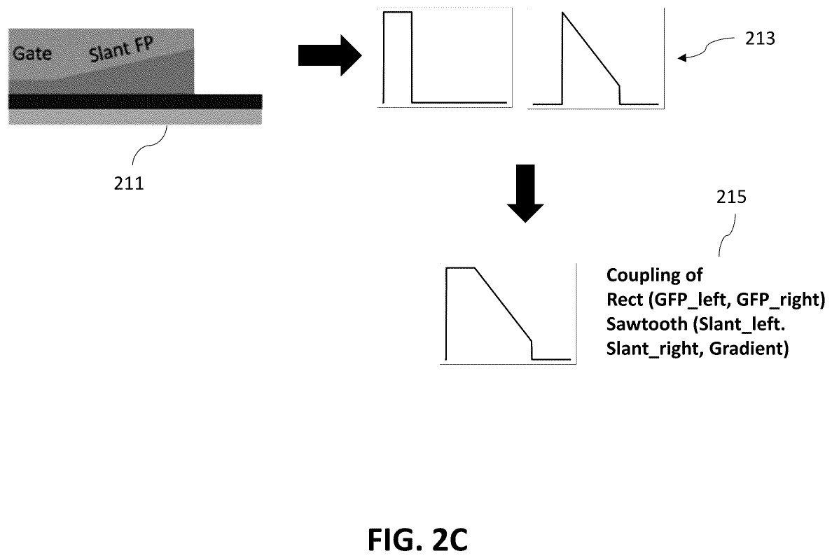

Towards this end, system 150 performs parametric reduction 157 on the complex 2D field plate structures which is described next with reference to FIGS. 2A and 2B which jointly illustrate schematics of a 2D field plate geometry transformation process, according to some embodiments. The system 150 aims to convert the field plate structure defined in the structural model 155 into features 159 with reduced dimensions—which can be efficiently captured and learned in a machine learning model such as a surrogate neural network model 161.

To streamline the analysis, the system 150 utilizes a converter 203 to project the 2D field plate structure and metal contact 201 into one-dimensional (1D) arrays 205, as depicted in FIG. 2A. Each unit within these arrays 205 represents various aspects of the field plate, such as metal plate thickness and oxide thickness above or below it. For the example shown in FIG. 2A, such a transformation results in a 3×N matrix, where N corresponds to the number of units in each array, based on the chosen resolution. For instance, with a transistor width of 4 μm and a resolution of 0.05 μm, each array comprises 80 features, necessitating a substantial amount of TCAD or experimental data to develop a reliable input to the machine learning model.

To address this data challenge, the system 150 implements a second transformation as a part of the parametric reduction 157, as depicted in FIG. 2B. The system converts 207 the 1D arrays 205 into a series of pulse functions 209A-209C, which is particularly effective given the sparse nature of the 1D feature array. In the example provided earlier in FIG. 2A, the metal plate array is transformed into three rectangular pulse functions 209A-209C, each requiring only two parameters (the left and right electrode locations):

F_{metal plate}(x)=Rect(x; Electrode Left, Electrode right)

The gate field plate array is transformed into two rectangular pulse functions, with just three parameters (Metal Thickness, Gate Field Plate Left and Gate Field Plate Right) for each function needed to represent the metal thickness and the field plate's location:

F_{gate plate}(x)=Metal Thickness*Rect(x; Gate Field Plate Left, Gate Field Plate Right)

Similarly, the source plate pulse function requires three parameters:

F_{source plate}(x)=Oxide Thickness*Rect(x; Soruce Field Plate Left, Source Field Plate Right)

For more intricate field plate structures, such as a slant field plate 211 shown in FIG. 2C, the system 150 may employ triangular, sawtooth, Gaussian, or other pulse functions 213 to decode the field plate's configuration 215. This method significantly reduces feature dimensions while retaining sufficient information for effective machine learning.

Referring back to FIG. 1B, the parametric reduction 157 results in features with reduced dimensions 159 that are provided as an input to the surrogate NN model 161. The surrogate model 161 connects the structural parameters of the field plate design of the semiconductor device with a performance metric of the semiconductor device including multiple variables having a Pareto Front. Accordingly, the surrogate NN model 161 predicts device performance metrics 163 corresponding to the features 159.

In some embodiments, following the feature transformation at 157, the TCAD dataset of TCAD simulator 153 may be utilized to train a robust neural network surrogate model 161, the hyperparameter of which is optimized via Bayesian Optimization. According to some embodiments, the dataset can be divided into one part (for example 80%) for training and another part (for example 20%) for validation and testing. The surrogate model 161 may have an architecture with one output layer corresponding to each performance metric predicted by the model 161.

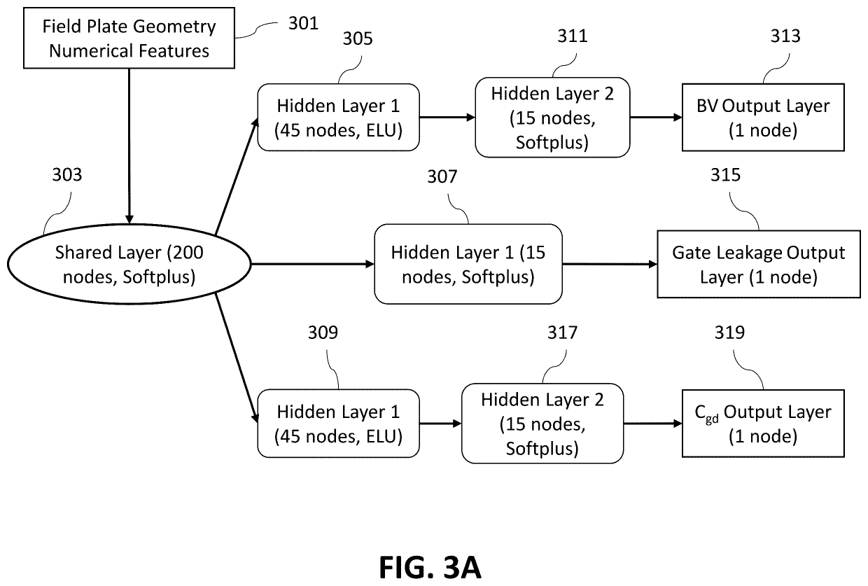

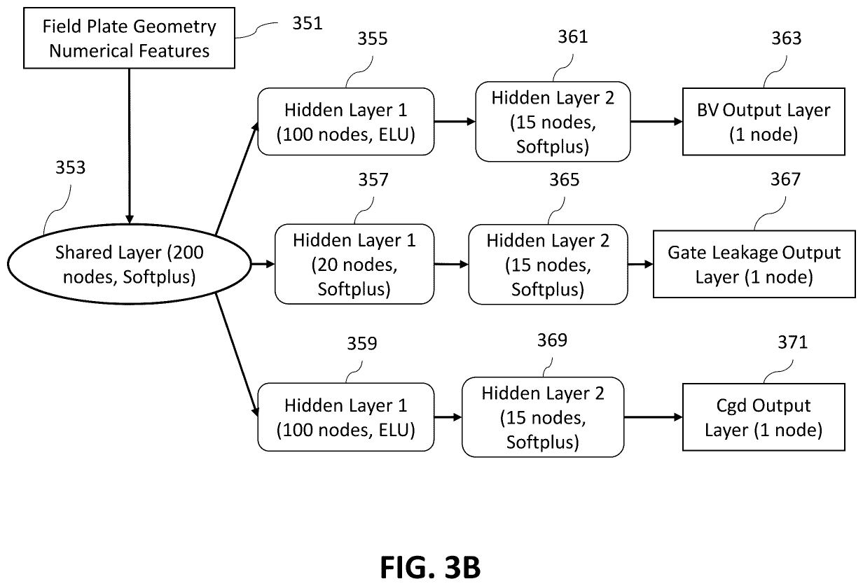

FIGS. 3A and 3B each illustrate an exemplary architecture of the surrogate model's neural network featuring three output layers, each responsible for predicting one of the performance metrics. As shown in FIG. 3A, the field plate geometry numerical features 301 are input to a shared layer 303 having 200 nodes. The shared layer 303 is shared with three hidden layers 305, 307, and 309. The hidden layer 305 has 45 nodes, the hidden layer 307 has 15 nodes, while the hidden layer 309 has 45 nodes. The hidden layer 305 is connected to another hidden layer 311 having 15 nodes which in turn is further connected to a single node BV output layer 313 that outputs the blocking voltage parameter. The hidden layer 307 is directly connected to the single node Gate leakage output layer 315 that outputs the gate leakage parameter. The hidden layer 309 is connected to another hidden layer 317 having 15 nodes which in turn is further connected to a single node C_{gd} output layer 319 that outputs the capacitance optimization variable.

Referring to FIG. 3B, the field plate geometry numerical features 351 are input to a shared layer 353 having 200 nodes. The shared layer 353 is shared with three hidden layers 355, 357, and 359. The hidden layer 355 has 100 nodes, the hidden layer 357 has 20 nodes, while the hidden layer 359 has 100 nodes. The hidden layer 355 is connected to another hidden layer 361 having 15 nodes which in turn is further connected to a single node BV output layer 363 that outputs the blocking voltage parameter. The hidden layer 357 is connected to another hidden layer 365 having 15 nodes which in turn is further connected to the single node Gate leakage output layer 367 that outputs the gate leakage parameter. The hidden layer 359 is connected to another hidden layer 369 having 15 nodes which in turn is further connected to a single node C_{gd} output layer 371 that outputs the capacitance optimization variable.

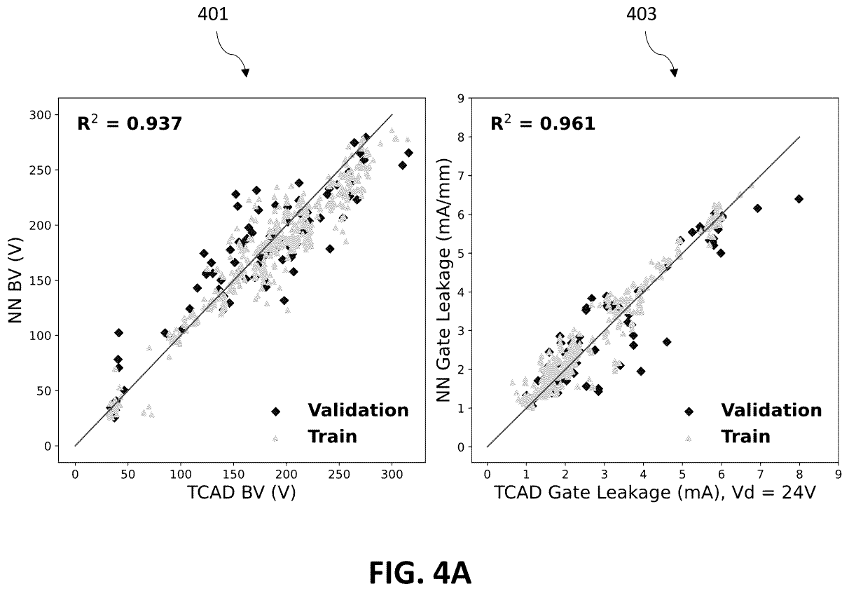

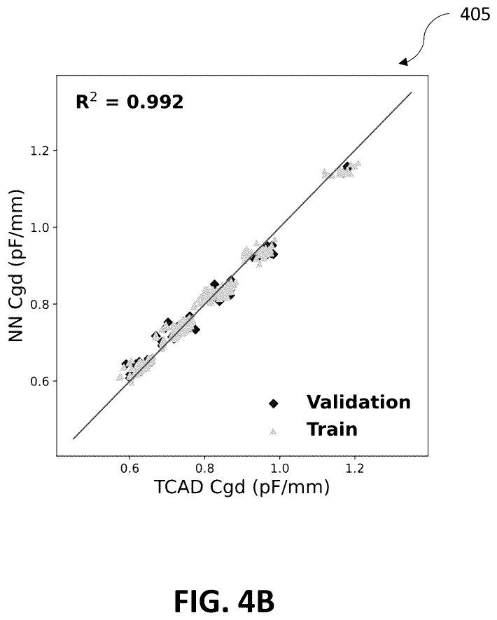

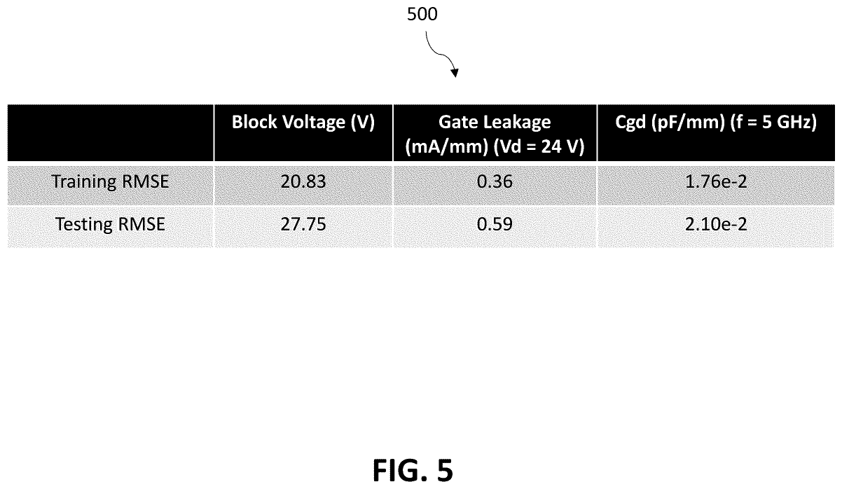

FIG. 4A illustrates the training and validation results corresponding to the blocking voltage (BV) 401 and the gate leakage current 403 of the semiconductor device. FIG. 4B illustrates the training and validation results corresponding to the capacitance variable 405. FIG. 5 illustrates table 500 showing the training and validation results corresponding to each performance metric 401-405 of FIGS. 4A and 4B. These results demonstrate the model's capability to well predict key metrics, including BV, C_{gd}, and gate leakage.

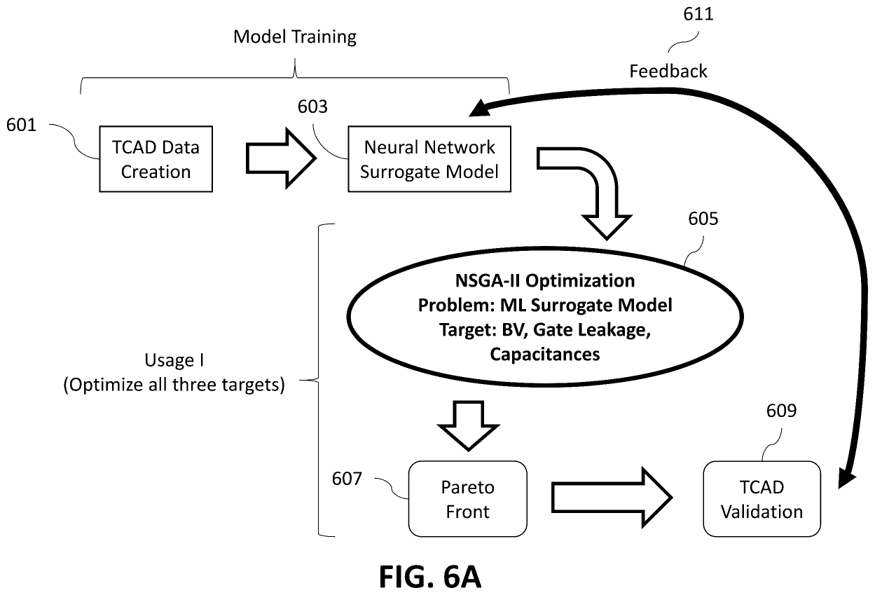

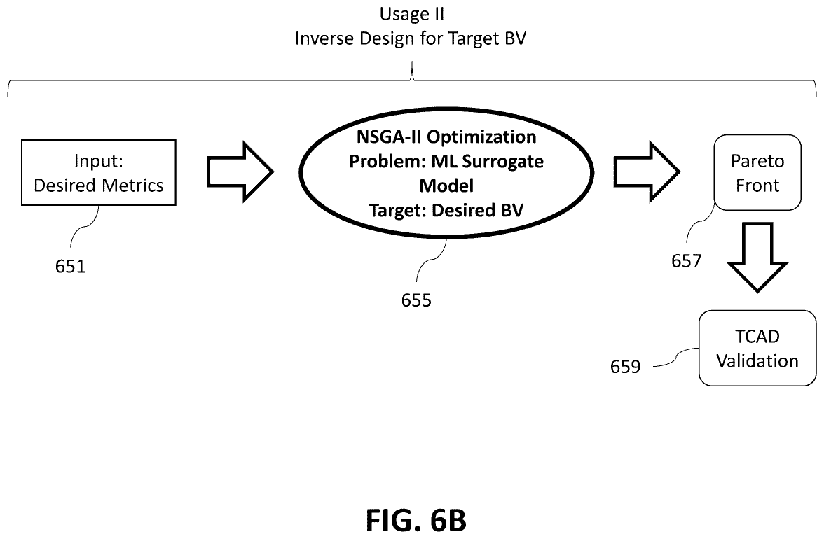

The surrogate NN model 161 in FIG. 1B corresponds to a NN model trained in the manner described above. The trained model 161 predicts device performance metrics 163 corresponding to the structural parameters. Subsequently, the system 150 deploys an AI-assisted optimization framework 165 which is described in detail with reference to FIGS. 6A and 6B. Referring to FIG. 6A, TCAD data 601 created for the semiconductor device field plate structure is obtained and provided to a NN surrogate model 603. The trained neural network model 603 is then integrated into the NSGA-II optimization framework 605 as an optimization problem to co-optimize the key performance metrics of the semiconductor device. For a GaN HEMT device, the key performance metrics include blocking voltage, gate leakage, and capacitance. These three metrics are optimized under the constraints of the physical dimension of device structures. There are two optimization strategies. The first one shown in FIG. 6A aims to optimize all three metrics, which involves maximizing BV while minimizing gate leakage and C_{gd}. The second strategy is shown in FIG. 6B targets a specific BV value while minimizing gate leakage and C_{gd}. The latter approach is commonly known as inverse design and is shown in FIG. 6B. The desired metric 651 is provided as input to the optimization framework 655.

The algorithm is illustrated in following equations:

$$max {f}_{BV} ( x ; {F}_{metal plate} , {F}_{gate plate} , {F}_{source plate} ) or$$

$$min abs ( Target BV - f {BV}_{} ( x ; {F}_{metal plate} , {F}_{gate plate} , {F}_{source plate} ) ) for inverse design$$

$$min {f}_{{gate}_{leakage}} ( x ; {F}_{metal plate} , {F}_{gate plate} , {F}_{source plate} )$$

$$min {f}_{{C}_{gd}} ( x ; {F}_{metal plate} , {F}_{gate plate} , {F}_{source plate} )$$

$$Subject to : Source Field Plate Right < Left of Drain$$

$$Source Field Plate Left > Gate Field Plate Left$$

$$Source Field Plate Right - Source Field Plate Left > 0$$

The optimization frameworks 605 and 655 provide the Pareto front points 607 and 657, respectively which are then further evaluated for TCAD validation 609 or 659.

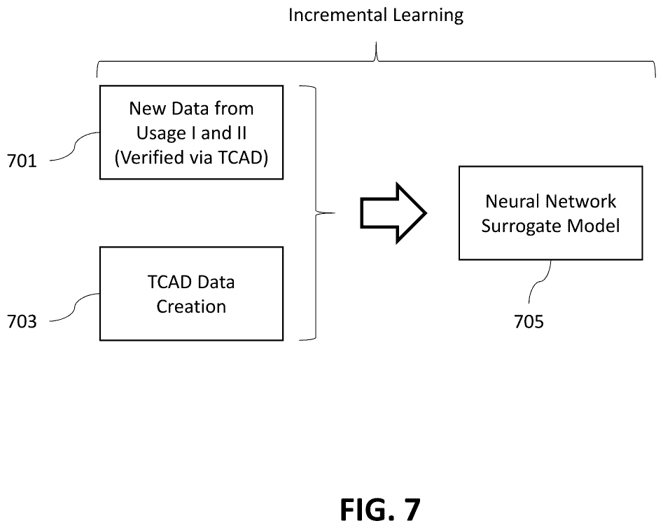

To further enhance the performance of surrogate model, some embodiments allow the surrogate model 705 to acquire new information 701 from Usage I (FIG. 6A) and II (FIG. 6B) along with TCAD data creation 703 and perform an Incremental Learning shown in FIG. 7.

Referring back to FIG. 1B, the optimization framework 165 can produce Pareto front points 167 representing potential optimal solutions. For training, subsequently, these solutions may be subjected to validation via TCAD models. The validation results from TCAD provide feedback to the system, which allows for tuning the neural network model to the best performance. For inference, the optimal solution may be utilized for further processing or control. For example, the Pareto Front points 167 may be utilized for fabrication control 169 of the semiconductor device or to simply generate a design of the semiconductor device.

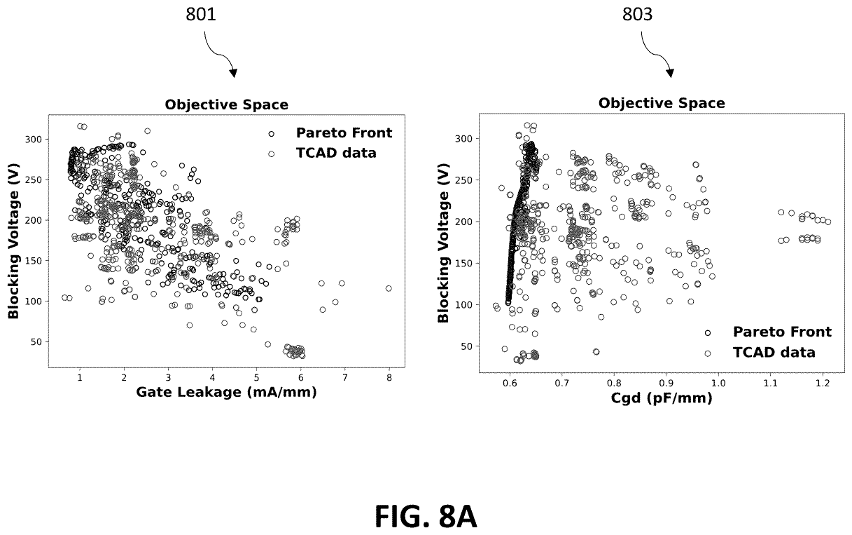

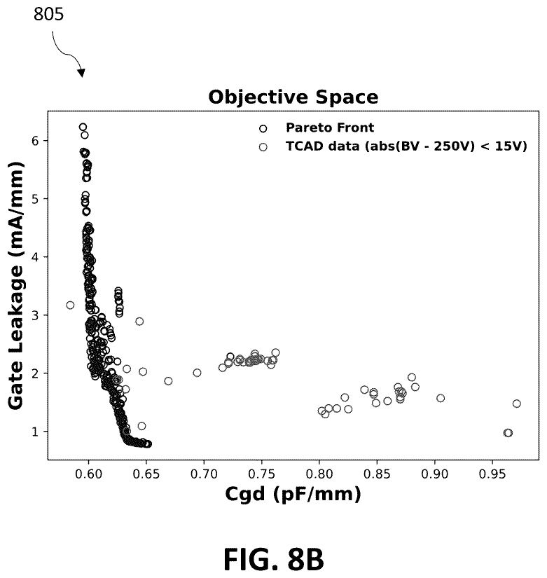

FIGS. 8A illustrates Pareto Front generated via AI-assisted model for device optimization, according to some example embodiments. The plot 801 on the left shows BV vs. Cgd and the plot 803 on the right shows BV vs. gate leakage. The dark dots indicate Pareto Front, while the light dots indicate TCAD simulation data.

FIGS. 8B illustrates Pareto Front for inverse design of GaN HEMT with a target blocking voltage 250V (Gate leakage vs. Cgd), according to some example embodiments. The dark dots indicate Pareto Front, while the light dots indicate TCAD simulation data with BV values close to 250V.

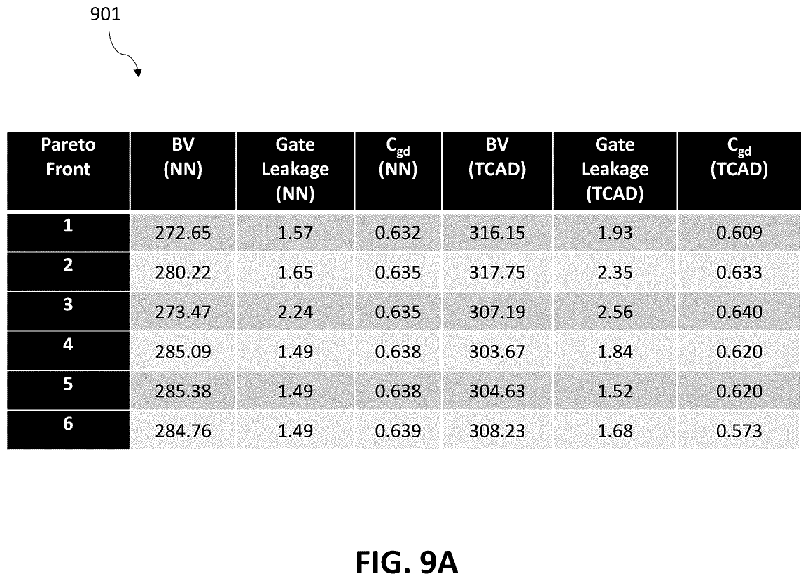

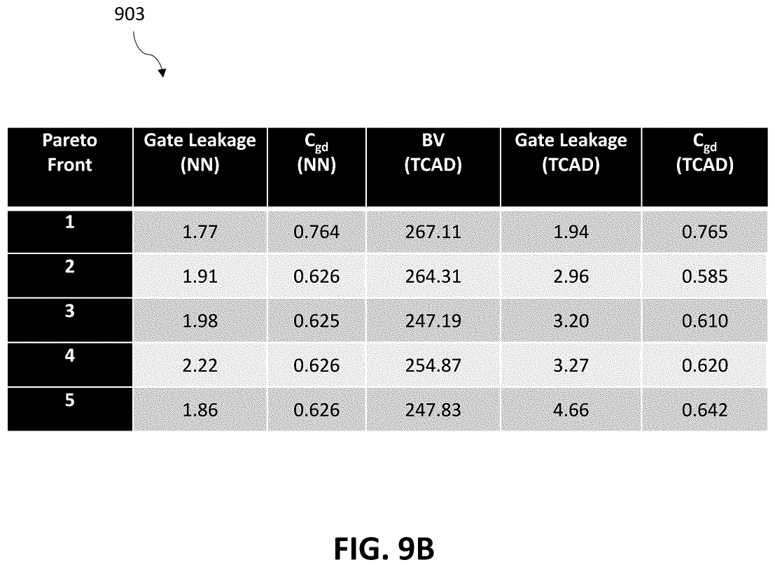

The validation results for both optimization strategies of FIG. 5A and 5B are shown in the tabular representations 901 of FIG. 9A and 903 of FIG. 9B. Particularly, FIG. 9A illustrates NN prediction and TCAD validation results of a subset of Pareto Front for BV (V), gate leakage (mA/mm) and Cgd (pF/mm) optimization while FIG. 9B illustrates neural network (NN) prediction and TCAD validations results of a subset of Pareto Front for inverse design with target BV of 250 V. It is noteworthy that the predicted BV values in the table are slightly below the maximum BV value from the TCAD data due to saturation. Nonetheless, it's important to highlight that the proposed approach demonstrates the capability to exceed the maximum BV value present in the TCAD data, suggesting that isn't a significant concern for the optimization process. In the context of inverse design, some embodiments set the target BV value at 250 V and obtained several feasible solutions through this framework. This not only allows to achieve the target BV value but also optimize gate leakage and capacitance concurrently.

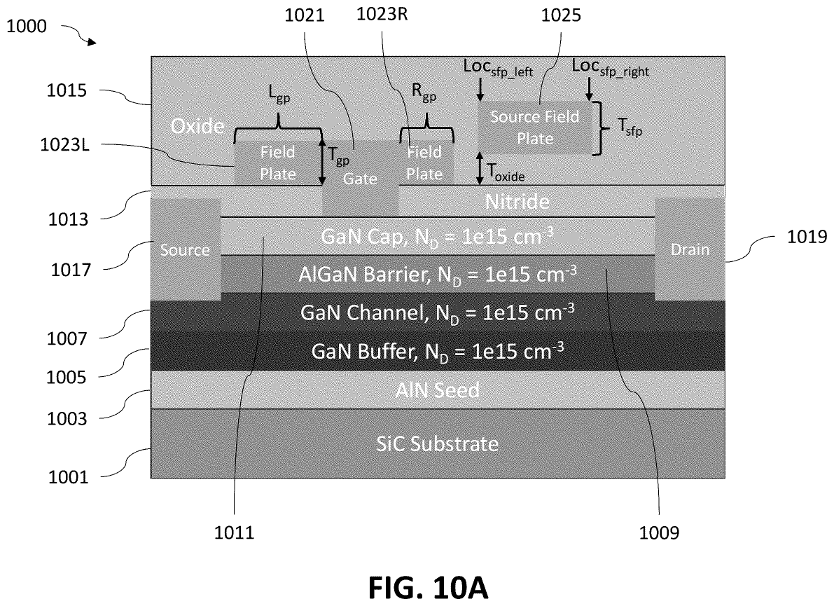

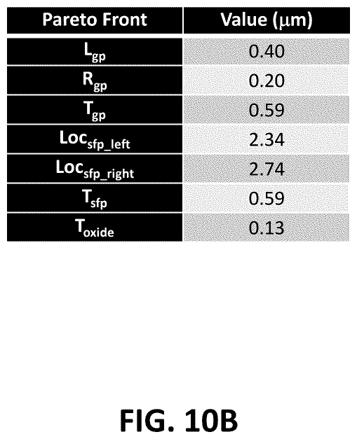

A schematic and detailed dimensions of device structure for Pareto Front 2 is shown in FIG. 10A and 10B. Particularly, FIG. 10A illustrates a 2D schematic of GaN HEMT device structure of Pareto Front 2 in Table 903 of FIG. 9B. The GaN HEMT 1001 comprises a Silicon Carbide (SiC) substrate 1001 on which an Aluminium Nitride AlN seed 1003 is grown. A GaN buffer layer 1005 is provided atop the seed layer 1003 and the GaN channel layer 1007 is grown on the buffer layer 1005. The GaN channel layer 1007 lies below an AlGaN barrier layer 1009 that is sealed with a GaN cap 1011. A nitride layer 1013 and an oxide layer 1015 serve as passive annealing layers for the HEMT 1000. Source electrode 1017, drain electrode 1019, and gate electrode 1021 are provided prior to annealing. The HEMT also comprises multiple field plates including a gate field plate, a left side gate field plate 1023L, a right side gate field plate 1023R, and a source field plate 1025.

From bottom to top, the device 1000 consists of the SiC substrate 1001, 0.1 μm AlN seed layer 1003, 2.0 μm GaN buffer layer 1005, 0.05 μm GaN channel layer 1007 built from epitaxy growth model, 0.02 μm AlGaN barrier layer 1009 built from epitaxy growth mode, 0.002 μm GaN cap layer 1011, 0.1 μm Si3N4 nitride layer 1013 and 0.2 μm oxide layer 1015. Among these layers, channel layer 1007, barrier layer 1009, and cap layer 1011 are built from epitaxy growth model. According to some embodiments, to focus on field plate design, the separation between source 1017 and gate 1021 may be fixed to be 1.0 μm and separation between gate and drain to be 2.0 μm. According to some embodiments, the lengths of source 1017, gate 1021, and drain 1019 are fixed to be 0.5 μm, 0.35 μm and 0.5 μm, respectively. The intentional rounding of contact corners during gate formation is employed to facilitate controlled tunneling and achieve a closer resemblance to practical applications.

According to some embodiments, two types of field plate structures may be considered: gate-connected field plate and source-connected field plate. The left side length of gate connected field plate may be fixed to be 0.4 μm as it has a minimal impact on blocking voltage optimization. Conversely, the right-side length of the gate field plate and the thickness of the gate metal may be adjustable. Regarding the source field plate structure, the horizontal location, vertical location, and field plate thickness can vary.

Referring to FIG. 10A, L_{gp} denotes the length of the left side gate field plate 1023L, R_{gp} denotes the length of the right side gate field plate 1023R, T_{gp} denotes the thickness of the gate field plates, Loc_{sfp_left} denotes horizontal location of left side of source field plate 1025, Loc_{sfp_right} denotes horizontal location of right side of source field plate 1025, T_{sfp} denotes thickness of source field plate 1025 and T_{oxide} denotes thickness of the oxide layer 1015 beneath source field plate 1025.

FIG. 10B illustrates the dimensions of the structure of the GaN HEMT 1000 of FIG. 10A.

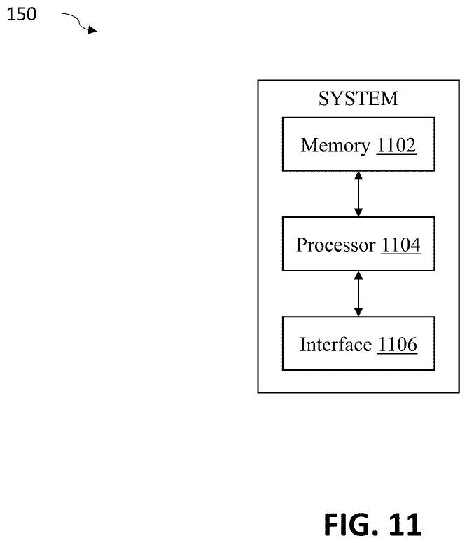

FIG. 11 illustrates a block diagram of some components of the system 150 of FIG. 1B, according to some embodiments. The hardware implementation of the system 150 comprises one or more processors 1104 coupled to a memory 1102 and an interface 1106. The one or more processors 1104 fetch data and computer programs from the memory 1102 and execute them to perform the method 100 of FIG. 1A. The system 1106 may perform data exchange with other components and systems through the interface 1106.

Therefore, example embodiments described herein present a groundbreaking method to optimize semiconductor devices, such as GaN HEMTs and their counterparts. By transforming complex field plate structures into a concise feature space and integrating them with machine learning, the described embodiments address a significant challenge in semiconductor device design. The proposed AI-assisted framework effectively enhances the design and performance of GaN HEMTs, even enabling inverse design capabilities. Moreover, the approach is versatile and can be applied to other transistors featuring field plate structures, making it a valuable tool for a broad range of semiconductor devices. This work represents a promising step forward in semiconductor device design, offering efficiency and reliability to meet the demands of high-power and high-frequency electronic applications.

The above description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements. Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks. Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Further, use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

What is claimed is:

1. A method for designing a field plate of a semiconductor device, the method comprising:
collecting a surrogate model connecting structural parameters of the field plate design of the semiconductor device with a performance metric of the semiconductor device including multiple variables having a Pareto Front;
evaluating, using the surrogate model, different combinations of the structural parameters of the field plate design resulting in the performance metrics lying on the Pareto Front to produce an optimal combination of the structural parameters; and
outputting the optimal combination of the structural parameters.

2. The method of claim 1, wherein the performance metric includes one or more of a blocking voltage, a gate leakage, a capacitance optimization variable, and current collapse.

3. The method of claim 1, wherein the structural parameters include distances between electrodes of the semiconductor device.

4. The method of claim 1, wherein the structural parameters include metal thickness of one or more electrodes of the semiconductor device.

5. The method of claim 1, wherein the structural parameters include thickness of gate field plate of the semiconductor device.

6. The method of claim 1, wherein the structural parameters include length of left side gate field plate and length of right-side gate field plate.

7. The method of claim 1, wherein the structural parameters include horizontal location of source field plate and vertical location of source field plate.

8. The method of claim 1, wherein the structural parameters include thickness of source field plate and length of source field plate.

9. The method of claim 1, further comprising generating a design of the semiconductor device, based on the optimal combination of the structural parameters.

10. The method of claim 1, further comprising controlling a fabrication controller to fabricate the semiconductor device, based on the optimal combination of the structural parameters.

11. A computerized system for designing a field plate of a semiconductor device, comprising:
memory configured to store instructions; and
at least one processor configured to execute the instructions to:
collect a surrogate model connecting structural parameters of the field plate design of the semiconductor device with a performance metric of the semiconductor device including multiple variables having a Pareto Front;
evaluate, using the surrogate model, different combinations of the structural parameters of the field plate design resulting in the performance metrics lying on the Pareto Front to produce an optimal combination of the structural parameters; and
output the optimal combination of the structural parameters.

12. The computerized system of claim 11, wherein the performance metric includes one or more of a blocking voltage, a gate leakage, a capacitance optimization variable, and current collapse.

13. The computerized system of claim 11, wherein the structural parameters include distances between electrodes of the semiconductor device.

14. The computerized system of claim 11, wherein the structural parameters include metal thickness of one or more electrodes of the semiconductor device.

15. The computerized system of claim 11, wherein the structural parameters include thickness of gate field plate of the semiconductor device.

16. The computerized system of claim 11, wherein the structural parameters include length of left side gate field plate and length of right-side gate field plate.

17. The computerized system of claim 11, wherein the structural parameters include horizontal location of source field plate and vertical location of source field plate.

18. The computerized system of claim 11, wherein the structural parameters include thickness of source field plate and length of source field plate.

19. The computerized system of claim 11, wherein the processor is further configured to generate a design of the semiconductor device, based on the optimal combination of the structural parameters.

20. A non-transitory computer readable medium having stored thereon computer executable instructions that when executed by a computer, cause the computer to perform a method for designing a field plate of a semiconductor device, the method comprising:
collecting a surrogate model connecting structural parameters of the field plate design of the semiconductor device with a performance metric of the semiconductor device including multiple variables having a Pareto Front;
evaluating, using the surrogate model, different combinations of the structural parameters of the field plate design resulting in the performance metrics lying on the Pareto Front to produce an optimal combination of the structural parameters; and
outputting the optimal combination of the structural parameters.
